(19) United States
(12) Patent Application Publication
(10) Pub. No.: US 2023/0366370 A1
(43) Pub. Date: Nov. 16, 2023

(54) WIND TURBINE ROTOR BLADE AND WIND TURBINE

(71) Applicant: Wobben Properties GmbH, Aurich (DE)

(72) Inventors: Muhanad Mahmoud, Aurich (DE); Jochen Stemberg, Aurich (DE); Hussam Daboul, Südbrookmerland (DE)

(21) Appl. No.: 18/302,450

(22) Filed: Apr. 18, 2023

(30) Foreign Application Priority Data
May 12, 2022 (EP) 22173045.0

(51) Int. Cl. F03D 1/06

(52) U.S. Cl. CPC F03D 1/0641; F05B 2240/301; F05B 2240/307

(57) ABSTRACT

Provided is a wind turbine rotor blade with a length, a rotor blade root, a rotor blade tip, a pressure side, a suction side, a leading edge, a trailing edge, a rotor blade depth, a rotor blade thickness and an air guide for heated air for guiding heated air along a longitudinal direction of the rotor blade from the rotor blade root in the direction of the rotor blade tip. The wind turbine rotor blade further has a deflection section, which is arranged in the area of the rotor blade tip and has a cross sectional surface that at least sectionally is at least constant toward the rotor blade tip or that at least sectionally enlarges toward the rotor blade tip.

### BACKGROUND

### Technical Field

The present invention relates to a wind turbine rotor blade and a wind turbine.

### Description of the Related Art

Since rotor blades of a wind turbine are exposed to all weather conditions unprotected, the rotor blades can become iced over at certain temperatures. A rotor blade heater can be used to prevent this. Either a heater can here be furnished on the exterior of the rotor blade, or heated air can be provided inside of the rotor blade. For example, this can take place by means of a heat register, which generates warm air, which is then blown into the interior of the rotor blade.

WO 2017/021350 A1 shows a wind turbine rotor blade with a rotor blade root area and a rotor blade tip area, as well as a rotor blade heater. At least one web is further provided along a longitudinal axis of the rotor blade. A deflection unit in the form of a web drop can be provided on the web, so as to reduce air turbulence during deflection.

WO 2018/211055 shows a wind turbine rotor blade with a rotor blade heater. The rotor blade has a web and a deflection unit in the area of the rotor blade tip for deflecting heated air.

### BRIEF SUMMARY

Provided is a wind turbine rotor blade that enables an improved heating of the rotor blade.

Provided is a wind turbine rotor blade with a rotor blade root, a rotor blade tip, a pressure side, a suction side, a leading edge, and a trailing edge. The rotor blade has a longitudinal direction. A rotor blade heater generates warm air, which then is blown into the interior of the rotor blade. At least one web is optionally provided between the pressure side and the suction side along the longitudinal direction of the rotor blade. The air heated by the rotor blade heater can be blown along the web in the direction of the rotor blade tip, where it is deflected, so that the heated air on the other side of the web can flow back from the rotor blade tip area to the rotor blade root area.

An enlargement of the cross sectional surface is provided in the area of the rotor blade tip, and can be provided in the deflection area for deflecting the heated air. Alternatively thereto, the cross sectional surface in the area of a deflection section can be held at least sectionally constant in the direction of the rotor blade tip.

The cross section or the cross sectional surface according to the invention represents the effective (inner) cross section available for an air flow.

According to an aspect of the present invention, a deflection section is provided in the area of the rotor blade tip, and its inner cross sectional surface (which forms the free surface for the air flow) is larger than in the adjacent sections (in the direction of the rotor blade root as well as in the direction of the rotor blade tip). This is advantageous, since this makes it possible to reduce the pressure losses that accompany a deflection of the air flow.

This deflection section with an enlarged cross section (in particular enlarged inner cross section) can be achieved by enlarging the blade depth, the profile thickness as well as a combination thereof.

According to another aspect, the deflection section can be achieved by providing a section with a constant blade depth progression in the direction of the longitudinal direction of the rotor blade, and in the direction of the rotor blade tip. In contrast, the blade depth in prior art continuously decreases in the direction of the rotor blade tip. According to one aspect of the invention, a section can thus be provided in which the blade depth does not continuously decrease in the direction of the rotor blade tip. Furthermore, a section can be provided in which the rotor blade depth is at least sectionally at least held constant or increased in the direction of the rotor blade tip.

Alternatively or additionally thereto, it is possible for the rotor blade thickness not to continuously decrease in the direction of the rotor blade tip, as is the case for a classic rotor blade according to prior art. Rather, a deflection section can be present, for which the rotor blade thickness does not decrease as a function of the length of the rotor blade, but at least partially increases. Alternatively thereto, the profile thickness of the rotor blade can be at least sectionally constant along the length of the rotor blade.

According to an aspect of the present invention, a hybrid solution is likewise possible, wherein both the blade depth and the blade thickness at least sectionally remain constant in the direction of the rotor blade tip.

According to another aspect of the present invention, the rotor blade depth and/or the rotor blade thickness can at least sectionally increase in the direction toward the rotor blade tip.

The rotor blade can be used (e.g., by enlarging the available flow cross section in the area of the rotor blade tip) to significantly reduce pressure losses in the air flow, which are used for heating the rotor blade. Furthermore, the flow rates of the air flow (in particular in the deflection area) can here be reduced. In addition, wall friction losses (in particular in the deflection area) can be minimized. This can result in an increase in the effective power of the blade heater, without having to here increase the electric power of the blade heater.

According to an aspect of the present invention, enlarging the flow cross section in the area of the rotor blade tip can lead to an enlargement of the construction and installation space in particular for air guide elements, e.g., for deflecting the air flow in the area of the rotor blade tip. These air guide elements can be used for implementing a resistance-optimized flow deflection by 180° in the area of the rotor blade tip. As a consequence, the air guided from the rotor blade heater along a web in the direction of the rotor blade tip can flow back toward the rotor blade root in a resistance-optimized manner. This makes it possible to also improve the heat transport of the rotor blade heater in the outer rotor blade area (i.e., in the area of the rotor blade tip).

According to an aspect of the invention, at least one section with an enlarged cross section between the rotor blade root and the rotor blade tip is provided.

According to an aspect of the invention, the section with an enlarged cross section has a length of up to 10% of the length of the rotor blade.

According to an aspect of the invention, the area of the rotor blade tip comprises an outer area of the rotor blade with a length of 10 to 30% of the length of the rotor blade.

According to an aspect of the invention, a length of the deflection section corresponds to up to 30% of the length of the rotor blade, or up to 15% of the rotor diameter.

Additional embodiments of the invention are the subject of the subclaims.

### BRIEF DESCRIPTION OF THE SEVERAL VIEWS OF THE DRAWINGS

Advantages and exemplary embodiments of the invention will be described in more detail below with reference to the drawing.

FIG. 1 shows a schematic view of a wind turbine according to the invention,

FIG. 2 shows a schematic, sectional view of the rotor blade of the wind turbine on FIG. 1,

FIG. 3A shows a schematic view of a rotor blade tip according to prior art, FIG. 3B shows a schematic view of a rotor blade tip according to an aspect of the present invention,

FIG. 3C shows a schematic view of a rotor blade tip according to another aspect of the present invention,

FIG. 4A shows a schematic view of a rotor blade tip according to prior art, FIG. 4B shows a schematic view of a rotor blade tip according to an aspect of the present invention,

FIG. 4C shows a schematic view of a rotor blade tip according to another aspect of the present invention,

FIG. 5A shows a schematic view of a rotor blade tip according to an aspect of the present invention,

FIG. 5B shows a schematic view of a rotor blade tip according to another aspect of the present invention,

FIG. 6A shows a schematic view of a depth progression of a rotor blade according to prior art,

FIG. 6B shows a schematic view of a depth progression of a rotor blade according to an aspect of the present invention,

FIG. 7A shows a schematic view of a profile thickness of a rotor blade tip according to prior art, and

FIG. 7B shows a schematic view of a profile thickness of a rotor blade tip according to an aspect of the present invention.

### DETAILED DESCRIPTION

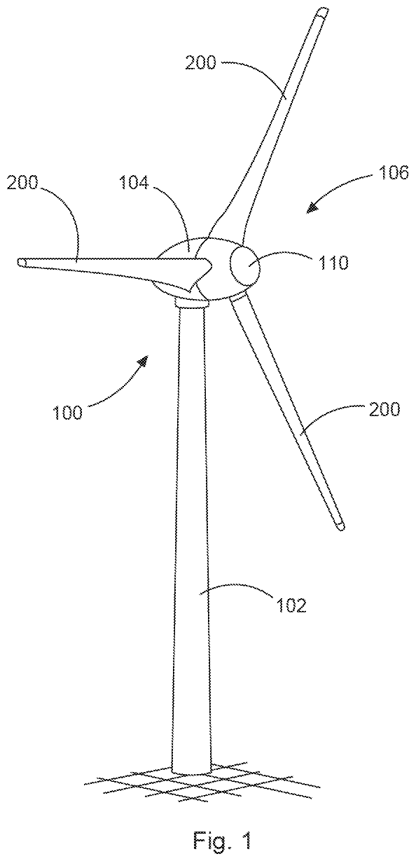

FIG. 1 shows a schematic view of a wind turbine according to the invention. The wind turbine 100 has a tower 102 and a nacelle 104 on the tower 102. An aerodynamic rotor 106 with three rotor blades 200 and a spinner 110 is provided on the nacelle 104. During operation of the wind turbine, the aerodynamic rotor 106 is made to rotate by the wind, and thus also rotates a rotor or runner of a generator, which is directly or indirectly coupled with the aerodynamic rotor 106. The electric generator is arranged in the nacelle, and generates electric energy. The pitch angles of the rotor blades 200 can be changed by pitch motors on the rotor blade roots 210 of the respective rotor blades 200.

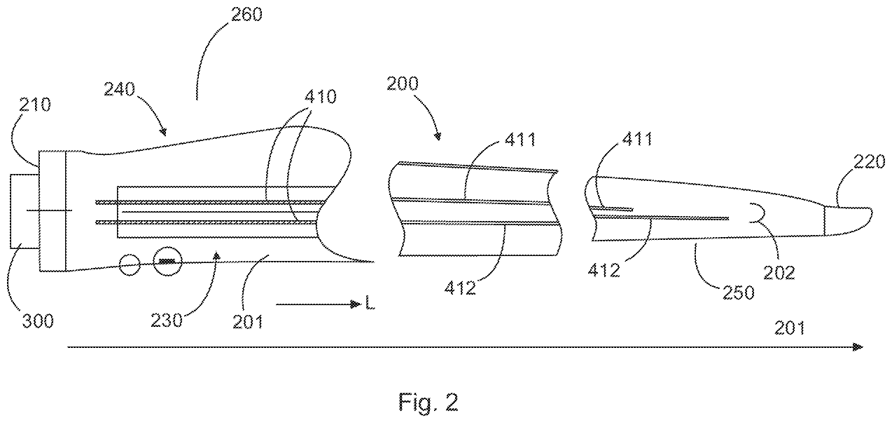

FIG. 2 shows a schematic, sectional view of the rotor blade of the wind turbine on FIG. 1. The rotor blade 200 has a length 201, a rotor blade root 210, a rotor blade tip 220, a leading edge 230, a trailing edge 240, a pressure side 250 and a section side 260. Provided inside of the rotor blade 200 is an air guide 400, for example which can be designed like a web 410. A rotor blade heater 300 can be provided in the area of the rotor blade root 210. The rotor blade heater 300 can have a fan and a heating unit, and generate warm air that can be guided into the interior of the rotor blade 200.

Extending along a longitudinal direction L of the rotor blade 200 inside of the rotor blade is at least one web 410, 411, 412, which is part of the air guide 400 or already present for other reasons, and the air guide 400 represents only a secondary function. More than one web can optionally be provided.

The air heated by the rotor blade heater 300 can be guided along the web 411, as part of the air guide 400, in the direction of the rotor blade tip 220, and then deflected in the area of the rotor blade tip 220. This provides a deflection section 202 in the area of the rotor blade tip 220. The rotor blade tip 220 can optionally be at least partially hollow in design, so that a part of the heated air can flow through the rotor blade tip, so as also to deice the rotor blade tip 220.

The heated air can be generated by means of the rotor blade heater 300 either in the rotor blade root area by heating the air with a heating unit, or the heated air is supplied to the rotor blade 200 in the area of the rotor blade root.

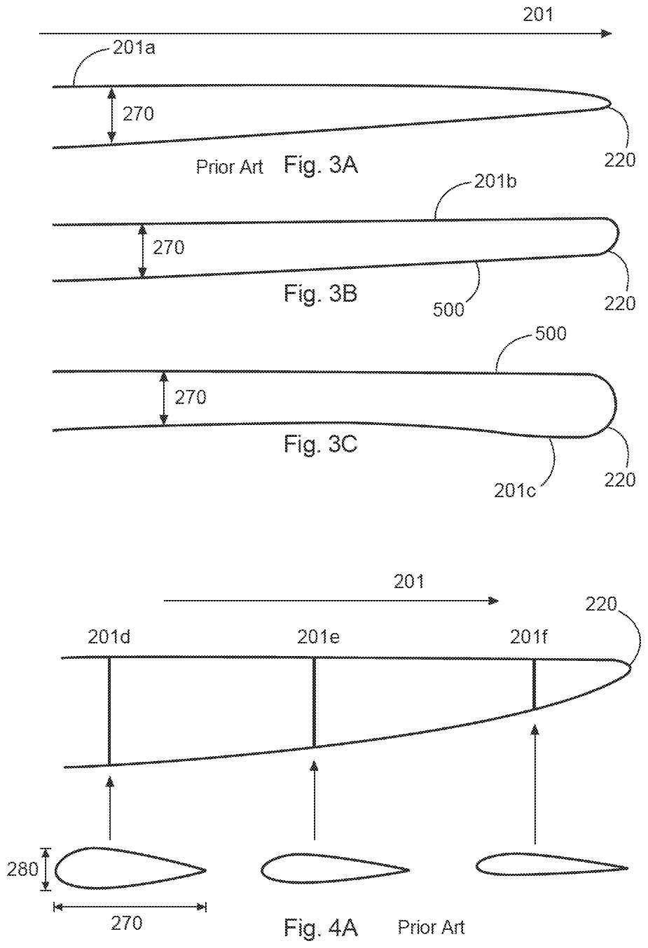

FIG. 3A shows a schematic view of a rotor blade tip according to prior art, and FIG. 3B shows a schematic view of a rotor blade tip according to an aspect of the present invention. FIG. 3C shows a schematic view of a rotor blade tip according to another aspect of the present invention.

FIG. 3A shows a rotor blade according to prior art, the rotor blade depth 270 of which continuously decreases toward the rotor blade tip 220 with an increasing length 201 of the rotor blade.

FIG. 3B shows a blade depth progression in the area of the rotor blade tip. As opposed to the continuously decreasing rotor blade depth according to prior art on FIG. 3A (continuous decrease in the rotor blade depth with increasing length of the rotor blade), the rotor blade depth 270 according to FIG. 3B at least sectionally has a constant value for the rotor blade depth given an increasing length 201 of the rotor blades. As a consequence, the deflection section 500 according to the exemplary embodiment on FIG. 3B is implemented as a section with a constant rotor blade depth given an increasing length of the rotor blade. An air guide element 202 can be provided in the deflection section 500.

According to FIG. 3C, a deflection section 500 is likewise provided in the area of the rotor blade tip 220. This deflection section 500 has a rotor blade depth 270 that becomes larger with increasing length 201, until the rotor blade depth is reduced at the rotor blade tip 220. The blade depth 270 at the location 201c can thus be greater than at a smaller length 201.

According to the exemplary embodiments described above, providing the deflection section 500 with a changed rotor blade depth can end up resulting in an aerodynamic influence. For example, this aerodynamic influence in the area of the rotor blade tip (high induction in the flow pipe of the rotor) can be offset by low-drive rotor blade profiles. Alternatively or additionally thereto, a torsion of the rotor blade can be adjusted. In particular, the blade section can here be twisted to smaller angles of attack, thereby only giving rise to slight uplifts, and hence to a lower induction.

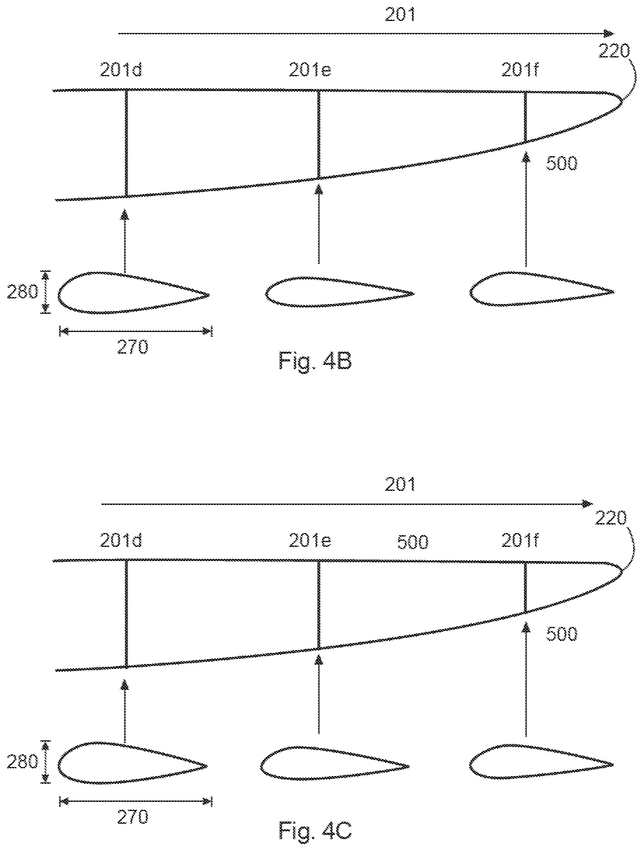

FIG. 4A shows a schematic view of a rotor blade tip according to prior art. The cross section of the rotor blade changes along a length 201 of the rotor blade. FIG. 4A depicts three different cross sections at lengths 201d, 201e and 201f. Both the rotor blade depth 270 and the rotor blade thickness here change. The rotor blade depth and the rotor blade thickness are reduced with an increasing length 201 of the rotor blade 200.

FIG. 4B shows a schematic view of a rotor blade tip according to an aspect of the present invention. As opposed to the rotor blade progression depicted on FIG. 4A, the rotor blade thickness 280 at the length 201e is smaller than at a length 201f, which is arranged closer to the rotor blade tip 220. The rotor blade thickness 280 is hence larger in an area closer to the rotor blade tip 220 than in an area further away from the rotor blade tip. As a consequence, the rotor blade section present at a length 201e is smaller than at a length 201d and a length 201f. Therefore, a section 500 (deflection section) is provided in the area of the length 201f that has a larger cross section than at a length arranged further away from the rotor blade tip 220.

Therefore, the progression of the relative profile thickness in the area of the rotor blade tip has a local minimum at a length of 201e. The relative profile thickness then increases again in the direction of the blade tip (at a length 2010. According to an aspect of the invention, the relative profile thickness can have a minimum, while the absolute profile thickness remains constant, or even falls strictly monotonously. However, it can also be the case that both the absolute and relative profile thicknesses have a minimum. However, the relative profile thickness has a minimum in each case.

FIG. 4C shows a schematic view of a rotor blade tip according to another aspect of the present invention. FIG. 3C depicts the rotor blade tip as well as three cross sections at the positions 201d, 201e and 201f. According to an aspect of the present invention, a section 500 (deflection section) is provided between the position 201e and 201f that has an essentially constant relative profile thickness 280. In other words, the rotor blade thickness 280 of the cross section at the length 201f essentially corresponds to the rotor blade thickness 280 at the length 201e. According to an aspect of the invention, the rotor blade thickness can be kept larger by not outwardly further reducing the relative profile thickness. However, this does not necessarily mean that the rotor blade thickness remains constant. It can also outwardly decrease. It is just that it decreases to less of an extent than in a design with an outwardly constantly decreasing relative profile thickness.

The rotor blade depth of the rotor blade is optionally not changed, i.e., the rotor blade depth does not deviate from the basic shape.

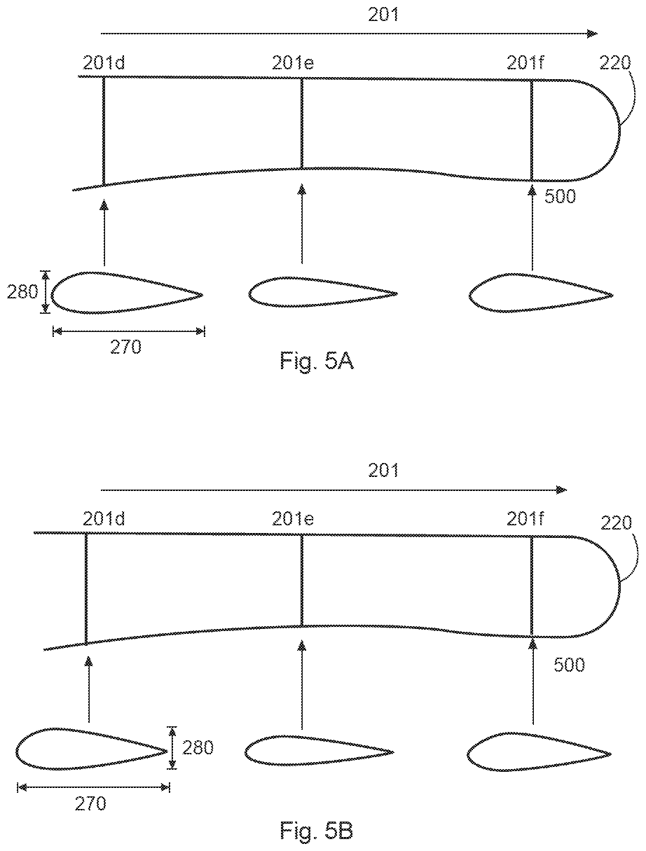

FIG. 5A shows a schematic view of a rotor blade tip according to an aspect of the present invention. The rotor blade depth 270 can be smaller along the length 201 of the rotor blade, in the area of the rotor blade tip 220, in the area of the length 201a than for the length 201f (which is closer to the rotor blade tip 220). In particular, a hybrid solution can be depicted on FIG. 5A. The rotor blade 200 can here have a constant, relatively high blade thickness 280, and a blade depth 270 that increases toward the tip 220. The absolute blade thickness can optionally outwardly increase. For example, the blade thickness 280 at the position 201e can correspond to the blade thickness 280 at the position 201f. Furthermore, the rotor blade depth 270 at the length 201f can be larger than at the length 201e, which can be located further away from the rotor blade tip.

As a consequence, a deflection section 500 with an enlarged effective cross section (i.e., inner cross section) can be provided in the area of the length 201f.

FIG. 5B shows a schematic view of a rotor blade according to an aspect of the present invention. FIG. 5B depicts another hybrid solution for configuring the deflection section 500. For example, the profile thickness increases in the direction of the rotor blade tip from a length 201e to a length 201f, while the rotor blade depth 270 also increases. In other words, both the rotor blade thickness and the rotor blade depth increase in the direction of the rotor blade tip. As a consequence, a deflection section 500 is provided in the area of the length 201f of the rotor blade 200.

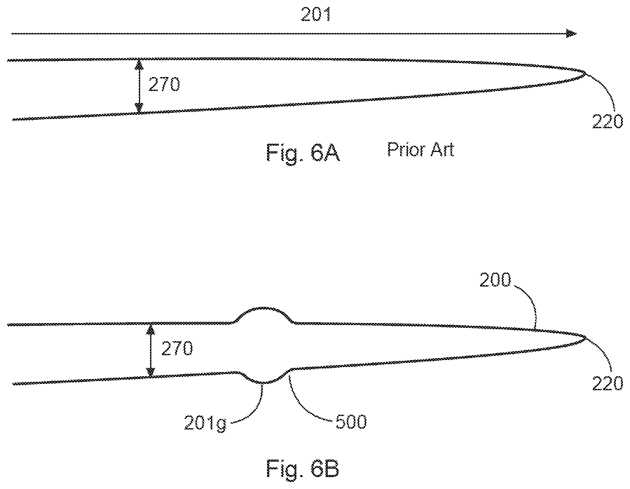

FIG. 6A shows a schematic view of a blade depth progression of a rotor blade according to prior art. FIG. 6B shows a corresponding view according to an aspect of the present invention. The rotor blade 200 on FIG. 6B provides a section 500 at a length of 201g which sectionally has a larger blade depth 270. The larger blade depth 270 makes it possible to enlarge a cross section of the rotor blade 200. Alternatively thereto, the blade thickness 280 can be sectionally increased. According to another aspect, both the blade thickness 280 and the blade depth 270 in the section 500 can be enlarged.

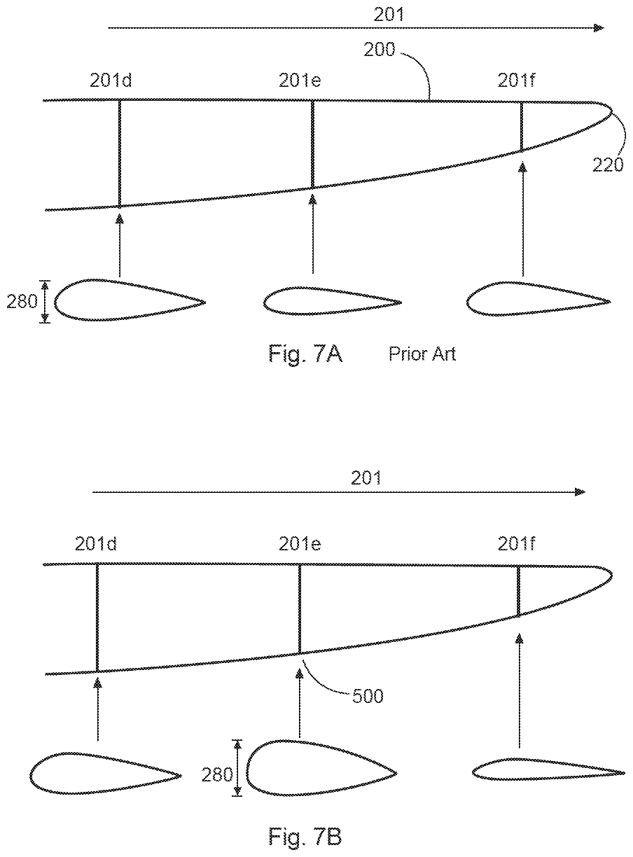

FIG. 7A shows a schematic view of a profile thickness of a rotor blade according to prior art, and FIG. 7B shows a schematic view of a profile thickness progression according to an aspect of the present invention. The profile thickness 280 is enlarged at the length 201e on FIG. 7B, so that a local thickening can be provided to allow implementation of the section 500, wherein the section 500 has a larger flow-relevant cross section.

According to another aspect of the present invention, additional sections with an enlarged flow cross section can likewise be implemented in the area of the rotor blade between the rotor blade root and the rotor blade tip, so that air guide elements can be used in this area. In order to enlarge the flow cross section, the rotor blade depth and/or the rotor blade profile thickness can be sectionally increased. The flow guide elements or flow control elements can comprise bypasses, deflection arcs or baffle plates.

The rotor blade according to the invention can make it possible to optimize air guidance or air flow given a hot air-based rotor blade heater inside of the rotor blade. Pressure losses inside of the rotor blade can be avoided by enlarging the flow cross section. The rotor blade according to the invention can be used to raise the efficiency of a hot-air blade heater. Providing the sections with an enlarged flow cross section in particular in the area of the rotor blade tip makes it possible to achieve the flow rates in the area of a deflection as well as a reduction in wall friction.

Both the rotor blade thickness 280 and the profile thickness 290 typically change along the length 201 of the rotor blade. The rotor blade thickness 280 and the profile thickness 290 typically decrease toward the area of the rotor blade tip 220. These changes are caused by both aerodynamic and production-related factors. The present invention proposes that there be a departure from these aerodynamic and production-related rotor blade progressions, and that a section be provided in the area of the rotor blade tip in which the rotor blade thickness and/or the profile thickness does not decrease, but rather at least sectionally at least remains constant. Such a departure of the rotor blade geometry from a conventional rotor blade geometry takes place so as to provide a section that permits a larger available flow cross section. An air deflection element can be placed in this section, in order to deflect heated air in the area of the rotor blade tip.

According to an aspect of the invention, the effectively, for an air flow inside of the rotor blade, available flow cross section in a section of the rotor blade can be enlarged in particular in the area of the rotor blade tip so as to improve a deflection of the air flow. In particular, this can be accomplished by likewise enlarging the space required for the deflection by enlarging the flow cross section. As a result, the available volume for corresponding air guide elements is likewise enlarged. This can allow for a larger variation of possible air guide elements.

In order to enlarge the effectively available flow cross section in the area of the rotor blade tip, either the rotor blade depth (profile depth) or the rotor blade thickness (profile thickness) can be increased. Furthermore, a combination of these two measures is also possible.

In order to increase the flow cross section, the rotor blade depth can be increased in the area of the rotor blade tip. This results in an enlargement of the rotor blade depth, for example given an identical profiling of the rotor blade. The absolute thickness of the rotor blade in comparison to the rotor blade according to prior art can optionally be increased.

In order to enlarge the flow cross section, the profile thickness in the area of the rotor blade tip can be increased. The rotor blade depth (as for rotor blades according to prior art) can here remain small, while the absolute thickness of the rotor blade is increased.

Both the rotor blade depth and the relative thickness of the rotor blade profile can optionally be increased, so as to enlarge the flow cross section. In particular, this can lead to a significant increase in the available flow cross section. The use of thicker profiles and a simultaneously increased blade depth here makes it possible to enlarge the flow cross section in the area of the rotor blade tip.

In rotor blades for which the entire blade tip is modified (e.g., see FIGS. 3a, 3b and 3c, FIGS. 4a, 4b and 4c, FIGS. 5a and 5b), the deflection sections can optionally have a maximum length of up to 30% of the rotor blade length or 15% of the rotor diameter. These rotor blades can optionally have a separation point.

In the variant with the local thickening or the local depth jump (FIG. 6b), the deflection area can optionally have a length expansion of at most 10% of the blade length.

The various embodiments described can be combined to provide further embodiments. These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of the equivalents to which the claims are entitled. Accordingly, the claims are not limited by the disclosure.

### REFERENCE LIST

100 Wind turbine
102 Tower
104 Nacelle
106 Rotor
110 Spinner
200 Rotor blades
201 Length
201a Length
201b Length
201c Length
201d Length
201e Length
201f Length
201g Length
202 Deflection section
210 Rotor blade root
220 Rotor blade tip
230 Leading edge
240 Trailing edge
250 Pressure side
260 Suction side
270 Rotor blade depth
280 Rotor blade thickness
290 Profile thickness
300 Rotor blade heater
400 Air guide
410 Web
411 Web
412 Web
500 Air deflection section
L Longitudinal direction

1. A wind turbine rotor blade, comprising
a rotor blade body having:
a longitudinal length,
a rotor blade root,
a rotor blade tip,
a pressure side,
a suction side,
a leading edge,
a trailing edge,
a rotor blade depth,
a rotor blade thickness,
an air guide for guiding heated air along a longitudinal direction of the rotor blade body from the rotor blade root to the rotor blade tip, and
a deflection section arranged in an area of the rotor blade tip and having a cross sectional surface, which:
at least sectionally is at least constant toward the rotor blade tip, or
at least sectionally enlarges toward the rotor blade tip.

2. The wind turbine rotor blade according to claim 1, wherein the air guide has at least one web arranged between the pressure side and the suction side and extends along the longitudinal direction of the rotor blade, wherein a deflection unit is provided in the area of the rotor blade tip.

3. The wind turbine rotor blade according to claim 2, wherein the rotor blade thickness and/or the rotor blade depth in the area of the deflection section is constant or enlarges with an increasing longitudinal length of the rotor blade body.

4. The wind turbine rotor blade according to claim 1, further comprising at least one section with an enlarged cross section between the rotor blade root and the rotor blade tip.

5. The wind turbine rotor blade according to claim 4, wherein the at least one section has a longitudinal length of up to 10% of the longitudinal length of the rotor blade body.

6. The wind turbine rotor blade according to claim 1, wherein the area of the rotor blade tip is provided with an outer area of the rotor blade with a longitudinal length of 10% to 30% of the longitudinal length of the rotor blade body.

7. The wind turbine rotor blade according to claim 1, wherein a deflection unit is provided in the area of the rotor blade tip, wherein a longitudinal length of the deflection section measures up to 30% of the longitudinal length of the rotor blade body.

8. A wind turbine comprising a rotor and at least one wind turbine rotor blade according to claim 1 coupled to the rotor.

9. The wind turbine according to claim 8, wherein a longitudinal length of the deflection section measures up to 30% of the longitudinal length of the rotor blade body or up to 15% of a diameter of the rotor.
